(19) United States
(12) Patent Application Publication
(10) Pub. No.: US 2024/0091568 A1
(43) Pub. Date: Mar. 21, 2024

(54) ROPE DESCENDERS

(71) Applicant: International Safety Components Ltd, Bangor, Gwynedd (GB)

(72) Inventor: Kevin Brown, Bangor, Gwynedd (GB)

(21) Appl. No.: 17/766,753

(22) PCT Filed: Oct. 16, 2020
(86) PCT No.: PCT/GB2020/000085

§ 371 Date: Apr. 6, 2022

(30) Foreign Application Priority Data
Oct. 18, 2019 (GB) GB1915078.8

(51) Int. Cl. A62B 1/14

(52) U.S. Cl. CPC A62B 1/14

(57) ABSTRACT

A descender (1) for controlling the descent of a climber down a rope (2) fixed to an anchor point (P), the descender comprising a primary rope-engaging means in the form of a cam lock (3) and associated rope entry guide (10), the camlock having a rope braking surface co-operable with the rope entry guide to partially or wholly lock the rope in response to movement of the rope, and handle means (9) to adjustably unlock the camlock to thereby wholly or partially release the rope and thereafter allow further descent from the anchor point, CHARACTERISED IN THAT the descender also includes a secondary rope engaging means (15) disposed in advance of the primary rope engaging means (3,10) and having an additional rope-engaging braking surface (16) adapted to, in use, selectively impart additional or alternative friction to the rope before it enters the primary rope-engaging means.

This invention relates to rope descenders of the type used by climbers when abseiling from a height.

### BACKGROUND OF THE INVENTION

GB2522179 (“D1”) describes a rope descender having a novel “cam within a cam” actuating mechanism by which the braking surface of a primary cam may be rotated by an operating handle into and out of engagement with a climbing rope releasably captured by the descender whereby to easily and accurately control the rate of descent. A separate feature also disclosed is an anti-panic arrangement whereby if the operating handle is rotated too much such that the primary cam is opened too widely and the climber effectively goes into freefall, the situation can be easily retrieved by the climber either continuing to rotate the handle in the same direction to thereby reactivate the braking system, or by letting go of the handle to thereby automatically operate the braking system. However, in each case braking is achieved using the same braking surfaces of the same cam. Other kinds of cam arrangements are known for the same ultimate purpose of releasably locking the cam against the rope and are collectively referred to herein as “camlocks” irrespective of their particular mode of operation, the cam in each case being actuated by means of a rotatable handle or lever actuated by the climber whereby to control the rate of descent.

The rope-engaging cam surface of a camlock for a rope descender is shaped to smoothly engage and grip the rope without cutting into it such that when the camlock is actuated and the cam braking surface is moved away from the rope then, depending upon the amount of separation, the rope is able to slide through the camlock with varying levels of ease, corresponding to varying levels of speed of descent. The most extreme of these varying levels of ease of descent is when the camlock is fully open, effectively allowing freefall of the climber, which is generally considered a dangerous event unless the climber is extremely experienced.

As will be appreciated from the foregoing, the risk of accidentally opening the camlock of a rope descender too greatly such that freefall or near freefall of the climber ensues should be avoided and whilst the anti-panic feature disclosed in D1 is a useful safety feature, for experienced climbers the risk of incorrect operation of the camlock is remote and the provision of such a safety feature is therefore unwanted, representing an unnecessary expense in terms of the additional cost of the feature as compared to descenders without such a safety feature, as well as the additional weight penalty that such may incur. However, even experienced climbers often prefer to descend in a more controlled manner than can usually be achieved by relying solely upon the use of a camlock and associated handle by using both hands to control the rope, one for the handle and the other for holding the trailing end of the rope before it enters the descender instead to control descent using one hand only, leaving the other hand free, such as where the descender is being used by military personnel and there is a requirement for the climber to hold a weapon.

Various other factors also affect the rate of descent for a climber including the climbers' weight, the condition of the climbing rope, which can become frayed after use, and its diameter relative to the size of the camlock, noting in particular that where the camlock is used in military situations the user is often under pressure to minimise total kit volume and weight, leading to the common use of relatively small diameter climbing ropes which are, by definition, often difficult to control with descent devices than with larger diameter climbing rope as conventionally used in sports climbing. This difficulty of control may be at least partly due to rapid degradation of the rope during passage through a descender, especially if it is of small diameter, or passage over abrasive surfaces such as rock formations. Accordingly, in such circumstances it is usual for the climber to use both hands during a descent, one to operate the camlock and the other to vary the entry angle of the rope before it enters the camlock, thereby increasing frictional resistance in order to further slow the descent. Where, however, it is essential for the climber to keep one hand free during descent for use in carrying e.g. a weapon, it will be understood that two-handed control of the descender is not desirable.

The present invention is derived from the realisation that there is a need for a secondary or alternative means of controlling descent down a climbing rope which selectively permits the climber to use only one hand during the descent whereby to compensate for factors such as the weight of the climber and the condition and size of the rope, which would otherwise require the climber to use both hands during a descent.

### SUMMARY OF INVENTION

According to the invention there is provided a descender for controlling the descent of a climber down a rope fixed to an anchor point, the descender comprising a primary rope-engaging means in the form of a camlock and associated rope entry guide, the camlock having a rope braking surface co-operable with the rope entry guide to partially or wholly lock the rope in response to movement of the rope, and handle means to adjustably unlock the camlock to thereby wholly or partially release the rope and thereafter allow further descent from the anchor point, CHARACTERISED IN THAT the descender also includes a secondary rope engaging means disposed in advance of the primary rope engaging means and having an additional rope-engaging braking surface adapted to, in use, selectively impart additional or alternative friction to the rope before it reaches the primary rope-engaging means.

With this arrangement the experienced climber has an option to guide the rope against the rope-engaging braking surface of the secondary rope-engaging means before the rope reaches the primary rope-engaging means, being the camlock and associated rope guide, whereupon friction against movement of the rope is separately increased as required by the climber whether or not the camlock is in use to provide a primary braking surface for the rope. Thus, in the event that the climber is experienced enough not to require the additional safety of a camlock anti-panic feature of the type described in D1 when descending a rope, or where no anti-panic feature is present but the climber nevertheless wishes to dispense with use of the primary rope-engaging means, the descent itself can be at least partially controlled by the climber placing the trailing end of the rope over the secondary rope-engaging means prior to the rope reaching the rope entry guide and subsequently varying the angular direction of travel into the camlock to thereby varied the frictional resistance on the rope, or simply let the free end of the rope dangle from the secondary rope-engaging means, whereby in each case to collectively introduce varying degrees of resistance to the rope before it is pulled through and over the primary rope-engaging braking surface of the camlock, which may typically be at least partially toothed. For rapid, but not freefall, descent the climber may therefore choose to engage the secondary rope engaging means before the rope enters the camlock to thereafter. control the descent using one and only via the handle, whereas in the event that the climber requires a slower and more controlled descent, this can be achieved by simultaneously using the other hand to manually increase the angular position of the rope relative to the rope entering the secondary rope engaging means, the result in each case being to effectively increase friction on the rope before it passes through the camlock.

In a preferred embodiment of the invention, the secondary rope-engaging means is positioned adjacent the load-bearing outgoing rope so that as the rope leaves the camlock under tension from the anchor point the incoming rope rubs against the outgoing rope from the camlock in this region to provide additional frictional resistance to the secondary rope engaging means. With such an arrangement the incoming rope presses against the tensioned outgoing rope from the camlock, forcing the tensioned part of the rope to move sideways in the horizontal direction, effectively providing a friction-inducing kink in the rope as it leaves the descender without any further rope-guiding interaction from the climber, thereby allowing the climber a free hand for other use, such as carrying a weapon.

Conveniently, the secondary rope engaging means includes a braking surface in the form of an open hook formed in a contoured flange projecting from the body of the descender along the travel path of the rope before it enters the rope entry guide of the camlock, the flange being shaped to change the direction of travel of the rope to thereby increase friction on the rope by effectively introducing an artificial kink in it before the rope reaches the entry guide to the camlock.

Preferably, the contoured flange of the secondary rope-engaging means is in the form of an outwardly extending wing having a trailing end relative to the direction of rope travel through the camlock during descent shaped to be smoothly contiguous with the body of the descender in that region, and having a leading end in the form of an open hook of diameter generally corresponding to the diameter of a climbing rope for use therewith, thereby allowing the climber to guide the rope against the hook in order to increase frictional resistance during descent.

### BRIEF DESCRIPTION OF THE DRAWINGS

The invention will now be described, by way of example only, with reference to the accompanying drawings in which:

FIG. 1 shows a general arrangement of how the descender of the invention is initially rigged with a climbing rope within an open rope descender,

FIG. 2 shows a general arrangement of how the rigged and closed descender of FIG. 1 is used in a first mode,

FIG. 3 shows a general arrangement of how the rigged and closed descender of FIG. 1 is used in a second mode,

FIG. 4 shows a side-view of the arrangement of FIG. 3 used in a refinement to the second mode of FIG. 3, and

FIG. 5 shows an exploded view of the descender of FIGS. 1 to 4.

### DETAILED DESCRIPTION OF THE DRAWINGS

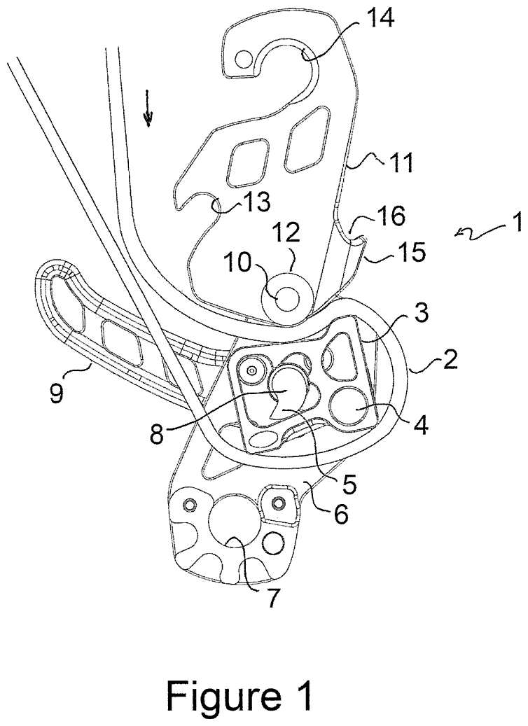

Referring firstly to FIG. 1, a rope descender 1 is shown in its fully open condition for receiving a climbing rope 2 wound around a camlock 3, the camlock acting, in use, as the primary rope-engaging means for imparting friction to the rope 2 and including gripping teeth (not shown) for that purpose. The camlock 3 is constrained to rock about a flanged pivot pin 4 within the limits imposed by an inner cam 5 which also serves to provide a mechanical advantage to the camlock in the manner as described in D1. At the lower end of the descender 1 is a rear plate 6 having a bore 7 for receiving a carabiner (not shown). Within the camlock 3 is a camshaft 8 to which is fixed at its front end the inner cam 5. The rear end of the camshaft 8 is attached to a handle 9 by which the camshaft 8 and inner cam 5 may be rotated to cause the camlock 3 to pivot about the pivot pin 4, this “cam within a cam” arrangement providing a convenient mechanical advantage obviating the need for a longer handle than the relatively short handle 9 shown. Extending from the upper end of the rear plate 6 is a fixed pivot post 10 to which is rotatably secured a front plate 11 parallel to the rear plate 6. The end of the pivot post 10 includes a flange 12 by which it rotably captures the front plate 11 thereon. The pivot post 10 also acts, in use, as an entry guide for the rope 2 as it is pulled into the camlock 3 in the direction arrowed. The front plate 11 includes a yoke 13 receivable around and under the flanged end of the pivot pin 4 when the front plate 11 is swivelled to a closed position covering the camlock 3. The front plate 11 also includes an open hook 14 having an internal diameter corresponding to the diameter of the bore 7 at the lower end of the rear plate 6 which collectively cooperate to receive and support a carabiner (not shown).

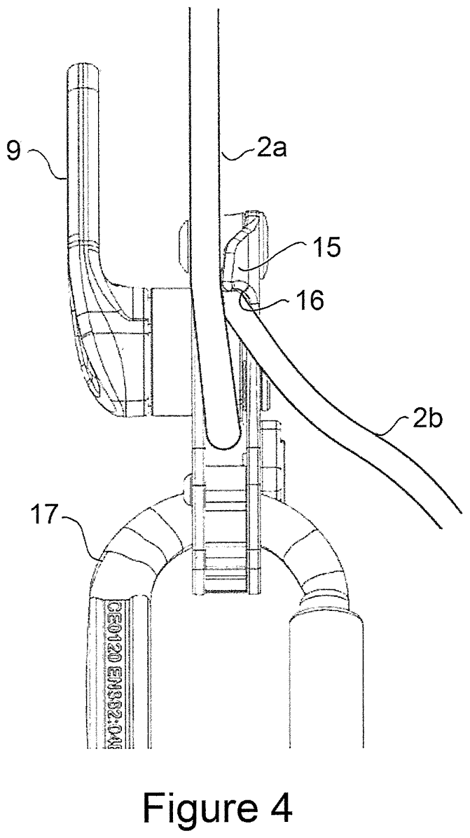

The arrangement thus-far described is conventional, generally corresponding to the descender of D1, but in accordance with the present invention the front plate 11 also includes a secondary rope engaging means in the form of a curved wing 15 extending outwardly from the front plate 11, having an open hook formation 16 of diameter generally corresponding to the rope 2, as more clearly described with reference to FIG. 4, although also usable with ropes of other diameters, particularly smaller diameters as used by military personnel or in emergency situations such as when abseiling from a burning oil rig or building, where there is a need for the escape kit, including the rope and the descender, to be as compact and lightweight as possible.

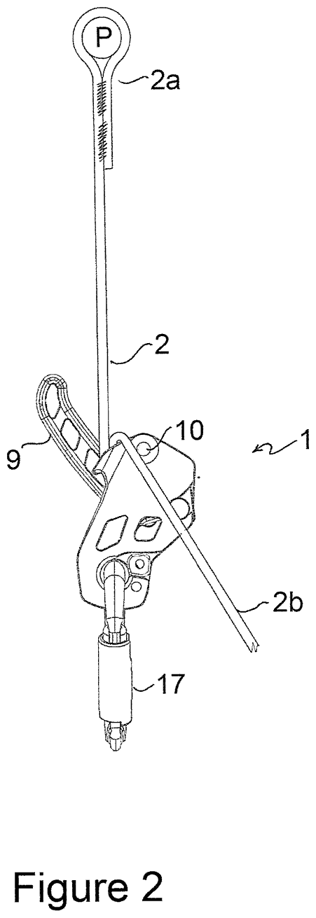

FIG. 2 shows the descender 1 of FIG. 1 in its fully closed and operational condition wherein the leading upper end 2a of the rope 2 is secured to an anchor point “P”, such as a carabiner (not shown), the trailing lower end 2b of the rope 2 entering freely into the descender 1 around the pivot post 10 of the descender 1 such that there is no noticeable frictional impediment to the rope 2 as it enters the camlock 3 during descent save to the extent that when it reaches the camlock 3 it automatically stops progress of the rope through the descender by moving the braking surfaces to its closed position to lock the rope. At the lower end of the descender 1 is a carabiner 17 for attachment to e.g. the climbing harness of a climber (not shown). To operate the descender 1, the handle 9 is rotated by one hand of a climber, thereby causing rotation of the camshaft 8 and associated inner cam 5 by which to open the camlock 3, as shown in FIG. 1. This, first, mode of operation is essentially equivalent to the mode of operation of the descender disclosed in D1.

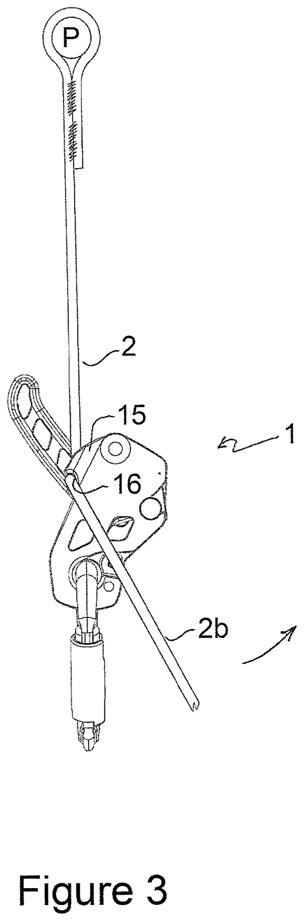

FIG. 3 shows a different, second, mode of operation to that shown in FIG. 2 in which the trailing end 2b of the rope 2 is wound over a secondary rope engaging means selectively acting as an extra frictional impediment to the rope before it enters the descender 1 around the pivot post 10, the extra impediment being in the form of a curved wing 15 and associated open hook 16 over which the trailing end 2b of the rope is partly wound and by which movement of the rope 2 into the descender 1 is partially impeded due to frictional resistance therebetween. In this, second, mode of operation the trailing end 2b of the rope 2 can be manipulated by the other hand of the climber (not shown) by moving the rope arcuately in the directions arrowed, the direction of movement corresponding to an increase in the angle by which the trailing end 2b of the rope 2 is forced to turn before reaching the rope entry guide/pivot post 10 of the descender 1. With this arrangement, the climber can operate the camlock using one hand and can control the angular position of the trailing end 2b of the rope relative to the secondary rope-engaging means 14 using the other hand before the rope enters the descender 1. However, in a preferred manner of operation, as shown in FIG. 4, the free end 2b of the rope is left to dangle freely, leaving the climber with a free hand.

FIG. 4 shows that, due to their respective proximity, as the trailing end 2b of the rope 2 is compressed between the rope-engaging means 15, 16 and the load-bearing upper portion 2a of the rope, which is pushed horizontally to one side relative to the normally vertical orientation of the upper portion 2a of the rope, the interaction therebetween providing additional friction to the friction imposed on the trailing end 2b of the rope as it enters the rope-engaging means 15, 16. Once the trailing-end 2b of the rope 2 has been captured by the rope-engaging means 15, 16, this is therefore sufficient to allow single-handed control of the descent via the handle alone without the climber having to use both hands, a significant advantage to a climber requiring use of the other hand to hold something else during the descent, e.g. a weapon in the case of a military user of the descender.

In both of the arrangements shown in FIGS. 3 and 4, the proximity of the secondary rope engaging means 15, 16 greatly increases the applied friction to the rope in this region. However, it will be understood that if the secondary rope engaging means 15, 16 were to be positioned remote from the node-bearing rope 2a so as not to touch or rub against it, the secondary rope engaging means 15, 16 is nevertheless still able to impart additional friction to the rope without the climber having to use both hands.

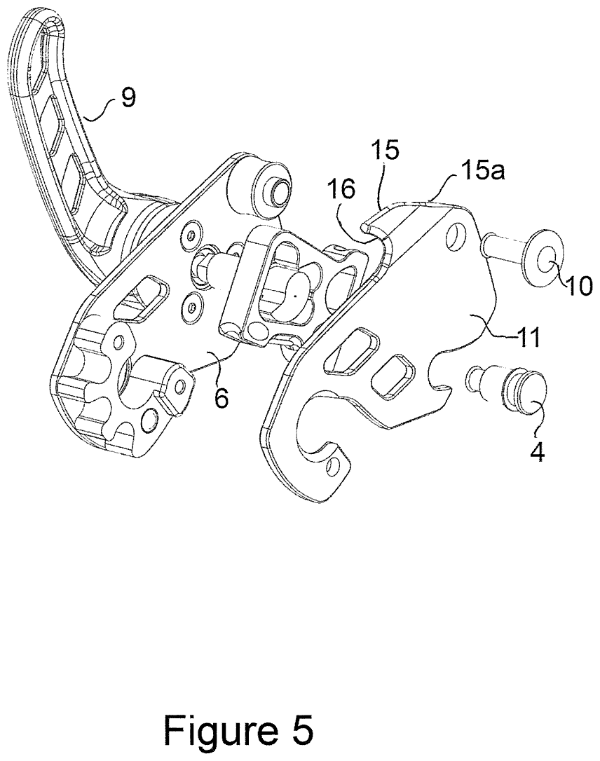

FIG. 5 is an exploded view of the descender 1 of FIGS. 1 to 4 in which it will be seen that the secondary rope engaging means extending from the front plate 10 is in the form of a wing 15 having a trailing end 15a relative to the direction of travel of the rope 2 through the descender 1 shaped to be smoothly contiguous with the front plate 11 so as to avoid unwanted snagging, and a leading end generally in the form of an open hook 16 against which the rope can be snagged. The presence of the smoothly shaped trailing end 15a of the secondary rope-engaging means 15, 16 allows the rope 2 to easily slide over and past it without snagging when the descender is being used in it primary mode only, but when the secondary mode is also selected by the climber, this smooth shape allows the trailing end 2b of the rope to be guided by hand into the open hook 16 in the event that the climber decides to increase frictional resistance on the rope 2 as it enters the descender 1 over the rope entry guide 10. The climber may thereafter choose to leave the secondary rope engaging means 15, 16 as a stand-alone means of imparting additional friction to the rope, thereby leaving one hand free for other purposes, or may choose instead to vary the amount of additional friction to the rope by varying the angle of the rope before it enters the secondary rope engaging means 15, 16. The invention therefore provides an elegantly simple means for experienced climbers to choose between conventionally operating the descender 1 with both hands (one on the handle and one controlling the rope 2b) or by using just the camlock 3 and associated handle 9 as the primary rope-engaging means.

Although the secondary rope-engaging means is described as being in the form of wing 15 having an open hook 16 it will, however, be apparent that other shapes may be used for effectively increasing frictional resistance on the rope 2 before it enters the camlock 3, provided only (we may not need this limitation—think about it?!) That whichever shape is adopted the angular position of the rope relative to the direction of travel as it enters the camlock 3 can be adjusted by the climber as required, or that the arrangement permits the rope to rub against itself to thereby increase friction, thereby allowing the climber to descend using only one hand to operate the descender.

1. A descender (1) for controlling the descent of a climber down a rope (2) fixed to an anchor point (P), the descender comprising a primary rope-engaging means in the form of camlock (3) and associated rope entry guide (10), the camlock having a rope braking surface co-operable with the rope entry guide to partially or wholly lock the rope in response to movement of the rope, and handle means (9) to adjustably unlock the camlock to thereby wholly or partially release the rope and thereafter allow further descent from the anchor point, characterized in that the descender also includes a secondary rope engaging means (15) disposed in advance of the primary rope engaging means (3, 10) and having an additional rope-engaging braking surface (16) adapted to, in use selectively impart additional or alternative friction to the rope before it enters the primary rope-engaging means.

2. A descender according to claim 1 further characterized in that the secondary rope-engaging means (15) is positioned, in use, adjacent the rope exit of the camlock (3) whereby to cause frictional engagement between the rope as it enters and leaves the camlock.

3. A descender (1) according to claim 1. Further characterized in that the secondary rope engaging means (15) includes an open hook (16) providing a braking surface for the rope when engaged therewith.

4. A descender (1) according to claim 3 further characterised in that the secondary rope engaging means (15) is in the form of a contoured flange projecting from the body of the descender along the travel path of the rope before it enters the rope entry guide (10), the flange (15) being partially hook-shaped (16) to change the direction of travel of the rope to thereby increase friction on the rope.

5. A descender (1) according to claim 4 further characterized in that the contoured flange of the secondary rope-engaging means is in the form of an outwardly extending wing (15) having a trailing edge (15a) relative to the direction of rope travel through the camlock during descent shaped to be smoothly contiguous with the body of the descender in the region, and having a leading end in the form of an open hook (16).
